(19) United States
(12) Patent Application Publication
(10) Pub. No.: US 2018/0313950 A1
(43) Pub. Date: Nov. 1, 2018

(54) CNN-Based Remote Locating and Tracking of Individuals Through Walls

(71) Applicant: Farrokh Mohamadi, Irvine, CA (US)

(72) Inventor: Farrokh Mohamadi, Irvine, CA (US)

(21) Appl. No.: 15/968,721

(22) Filed: May 1, 2018

Related U.S. Application Data
(60) Provisional application No. 62/492,787, filed on May 1, 2017.

(51) Int. Cl. G01S 13/88; G01S 13/02; G01S 13/89; G01S 7/22; G01S 7/41

(52) U.S. Cl. CPC G01S 13/888; G01S 13/0209; G01S 7/417; G01S 7/22; G01S 7/415; G01S 13/89

(57) ABSTRACT

A system and method is provided to quantize a plurality of search bins within a structure with a label corresponding to whether an UWB radar sensor has detected an individual within the search bin to produce a labeled image of plurality of search bins. A convolutional neural network classifies the labeled image regarding how many individuals are shown in the labeled image.

### CROSS-REFERENCE TO RELATED APPLICATIONS

This application claims the benefit of U.S. Provisional Application No. 62/492,787, filed May 1, 2017, the contents of which are hereby incorporated by reference in their entirety.

### TECHNICAL FIELD

This application relates to remote sensing, and more particularly to the remote sensing and tracking of individuals through structures such as walls.

### BACKGROUND

The monitoring of individuals through walls is challenging. For example, first responders such as police are subject to attack upon entering a structure with hostile individuals. The risk of attack or harm to the police is sharply reduced if the location of hostile individuals within the structure are known before entry. Similarly, the opportunity to save lives is increased if firemen or other emergency responders know the location of individuals prior to entry. But conventional remote sensing of individuals through walls is vexed by low signal-to-noise ratios. It is difficult for a user to discern between individuals and clutter. Moreover, it is difficult for a user to identify motionless individuals.

Accordingly, there is a need in the art for the development of autonomous systems for the sensing and tracking of individuals through walls.

### BRIEF DESCRIPTION OF THE DRAWINGS

FIG. 1 is a block diagram for an example UWB radar sensor.

FIG. 2A illustrates the triangulated radar data resulting from pacing of individuals within a structure as imaged through a wall by a pair of stationary UWB radar sensors.

FIG. 2B illustrates the triangulated radar data of FIG. 2A after quantization.

FIG. 3 illustrates three example quantized radar images of scanned individuals.

FIG. 4 illustrates a CNN processing technique for automatically classifying quantized radar images into the three categories illustrated in FIG. 3.

FIG. 5A the triangulated radar data resulting from the pacing of one individual and detection of breathing by a motionless individual within a structure as imaged through a wall by a pair of stationary UWB radar sensors.

FIG. 5B illustrates the triangulated radar data of FIG. 5A after quantization.

FIG. 6 illustrates a plurality of UWB radar sensors stationed along the perimeter of a structure for imaging the walls and partitions within the structure.

FIG. 7 illustrates the received signal waveforms from the horizontally-located UWB radar sensors of FIG. 6.

Embodiments of the present disclosure and their advantages are best understood by referring to the detailed description that follows. It should be appreciated that like reference numerals are used to identify like elements illustrated in one or more of the figures.

### DETAILED DESCRIPTION

To provide a robust system for monitoring and tracking of individuals through walls, an ultra wide-band (UWB) radar is combined with a convolutional neural network (CNN) for the identification and tracking of individuals in the returned radar signal received by the UWB radar. In this fashion, the CNN enables the UWB radar to autonomously track and monitor individuals through walls, even if the individuals are motionless.

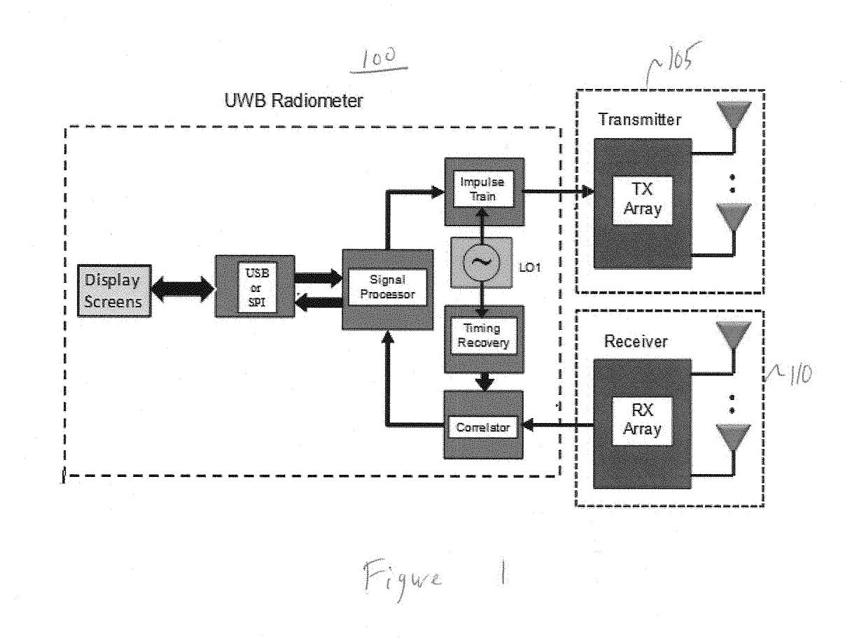

A block diagram for a suitable UWB radar 100 is shown in FIG. 1. A local oscillator (LO1) and a signal processor trigger a train of impulses into a transmitting array of antennas 105. The UWB pulses may repeat at a desired pulse repetition frequency (PRF) in the 1 to 10 GHz band. Although higher PRFs may be used, pulses in the 1 to 10 GHz band readily penetrate glass, wood, dry wall, and bricks with varying attenuation constants. By varying the PRF, the surveillance range varies accordingly. The resulting Gaussian pulses identify motion, breathing, or heartbeat of individuals hidden behind walls.

The resulting returned pulses from the structure being scanned are received on a receiving array of antennas 110. A correlator as timed by a timing recovery circuit correlates the received train of pulses to provide a correlated output to the signal processor. For example, the signal processor may perform a discrete fourier transform (DFT) on the correlated output signal from the correlator to drive a display screen (or screens) through a suitable interface such as a USB or SPI interface. Additional details of suitable UWB radars for the detection of living individuals behind walls may be found in U.S. Pat. Nos. 8,368,586 and 8,779,966, the contents of which are incorporated herein in their entirety.

The signal processor receives the “bounce-back” from the transmitted pulse train and builds the image of reflections for classification based on the size of an object (effective cross section). Note that the wide spectrum of frequencies in the received pulse train enables high sensitivity for motion detection. A Doppler radar cannot be as sensitive as it focuses on a single or multi-frequency motion processing. Both the transmitter array and the receiver array are provided with highly directional beam forming enabling advantageous sensitivity of detecting trapped or concealed persons inside a room as UWB radar system 100 can detect millimeters of chest movements.

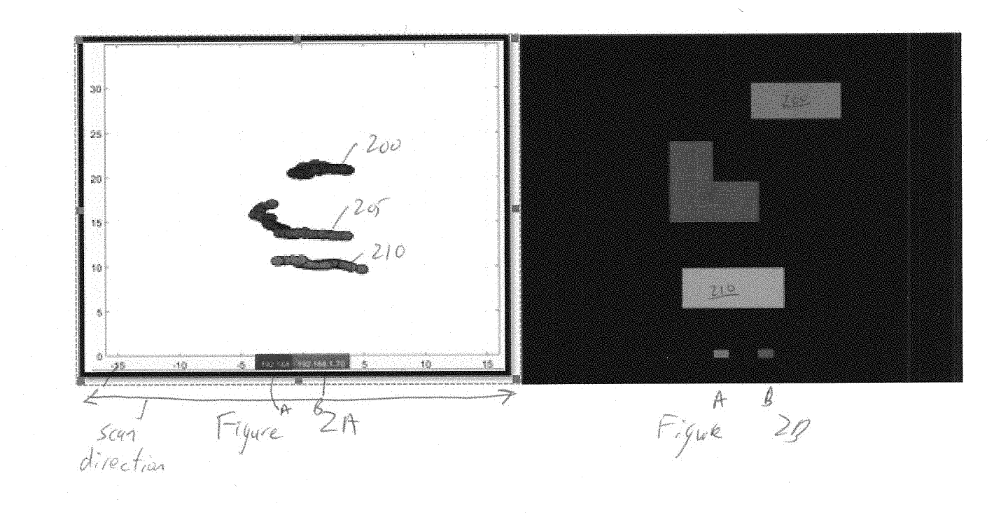

The resulting DFT magnitude at various ranges from UWB radar system 100 may be quantized by area to classify the space within the scanned structure. For example, consider the scan results shown in FIG. 2A. In this case, two UWB radar systems 100 were located several feet apart along the middle of an approximately 30 foot long outside wall of a structure to be scanned. It will be appreciated that a larger plurality than just two UWB radar sensors may be used in alternative embodiments. A plurality of two or more stationary UWB radar sensors enables the triangulation of scan data. The resulting triangulated scan data is quantized into 5 foot by 5 foot spaces or areas. It will be appreciated that more fine quantizing (for example, 1 foot by 1 foot) may be performed in alternative embodiments. As shown in FIG. 2A, motion was detected from an individual 200, 205, and 210. One UWB radar sensor is located at location A whereas another is located at location B approximately 5 feet away. The scanned space after quantization into the 5 foot by 5 foot areas is shown in FIG. 2B. The resulting quantization is denoted herein as “quantized labeling” in that each quanta of space is either deemed to contain no target (no individual) or to have the presence of a target (movement detected from an individual). Note that this movement may merely be the breathing of a motionless individual or even just the heartbeat of a motionless individual holding their breath. Alternatively, the motion may be that of a pacing or moving individual.

Based upon the type of motion detected, each quanta of area in the scanned structure may be labeled whether the breathing of a motionless individual is detected. Such a quantized labeling is denoted herein as a “motionless label” (ML). Alternatively, if the detected motion results from pacing (walking or other forms of gross movement of an individual), the quantized labeling is denoted herein as a “pacing label” (PL). Each quantized area in the scanned structure is thus labeled ML, PL, or no motion detected.

The image resulting from the labeled quantized areas are then machine vision processed through a convolutional neural network (CNN). To speed the training of the CNN, a transfer learning technique may be used in which a pre-existing commercial-off-the-shelf (COTS) CNN such as the Matlab-based “Alexnet” which has been trained on an ImageNet database having 1.2 million training images and 1000 object categories. The following discussion concerns the CNN processing of the received signal from a single UWB radar but it will be appreciated that the disclosed CNN processing is readily adapted to the processing of multiple received signals from a corresponding plurality of UWB radars.

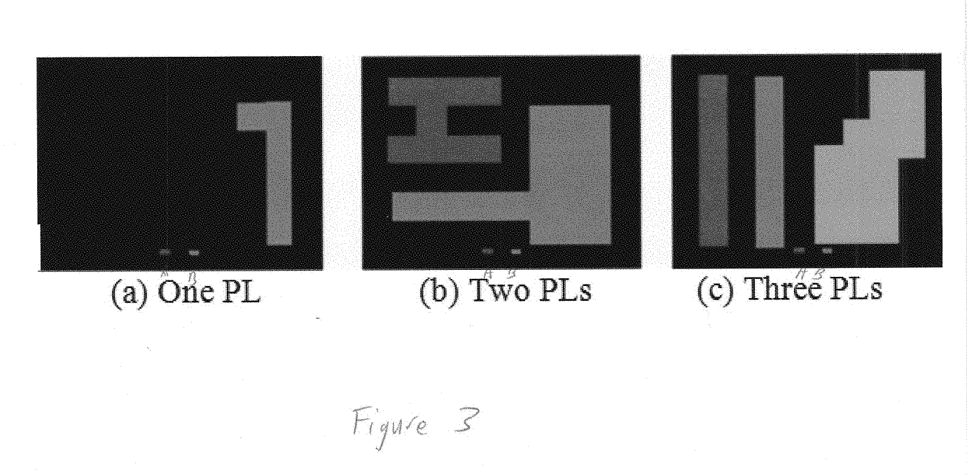

The CNN processing of labeled quantized images with regard to the machine (autonomous) identification of one pacing individual (1 PL), two pacing individuals (2 PLs) and 3 pacing individuals (3 PLs) will now be discussed as shown in FIG. 3. Next, the CNN image features were used to train a multiclass linear support vector machine (SVM) classifier. A fast Stochastic Gradient Descent (“SGD”) solver is used for training and setting the ‘Learners’ parameter to ‘Linear’. This speeds-up the training when working with high-dimensional CNN feature vectors, each have a length of 4,096. The sets of labeled quantized images were split into training and validation data. Thirty percent (30%) of each set of images was used to train the data and the remaining, seventy percent (70%) was used for data validation. The splits were also randomized to avoid biasing the results. The training and test sets were then processed by the CNN model.

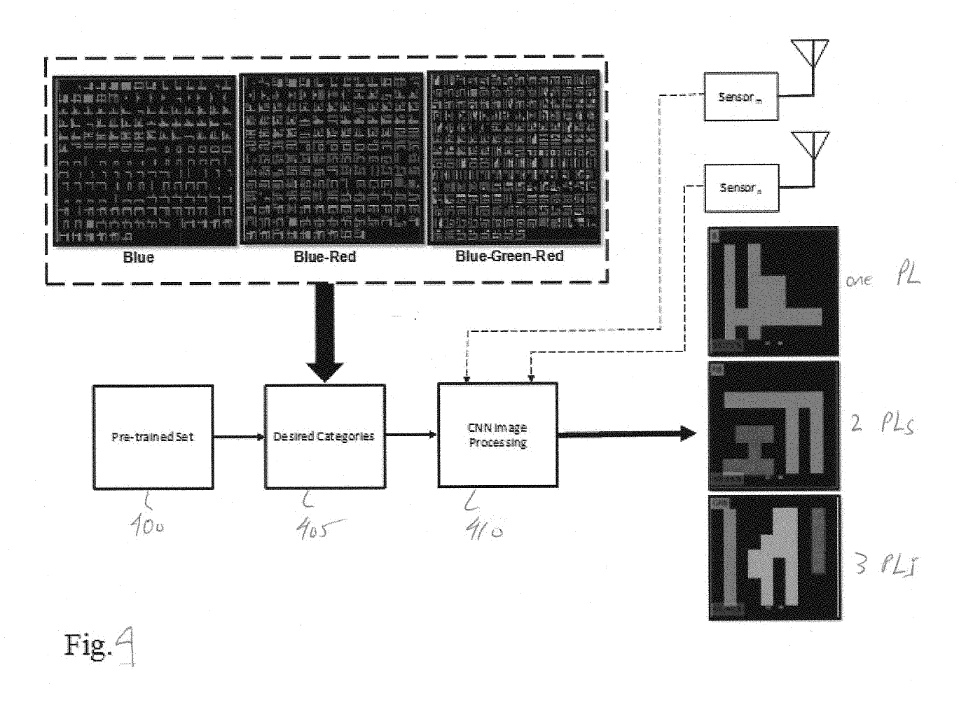

FIG. 4 demonstrates the CNN predicted images from the three categories. The pre-trained CNN 400 CNN provides a well improved prediction capability of the unseen images and is thus an ideal solution for achieving remote detection and reporting for surveillance and security applications (e.g., first responder assistance in visually impaired scenarios, unauthorized intrusion detection and protection of high impact assets). Pre-trained CNN 400 is then trained on the 1 PL, 2PLs, and 3 PLs image categories in a step 405 before the resulting trained CNN 410 is used to classify unseen images from the data set. Note that removing the color from the labeled quantized images and re-running the program on binary images (black and white) yielded less than a 7% accuracy loss but achieved a considerable reduction in processing time. The statistical accuracies of prediction are 96%, 85% and 95% for the detection of one, two, and three individuals' presences and pacing, respectively. In this test, all unseen objects were correctly identified. One hundred and sixty five (165) samples were used for each category. The processing time was about 15 minutes, however post-processing, the identification of an unseen labeled image occurs in virtual realtime.

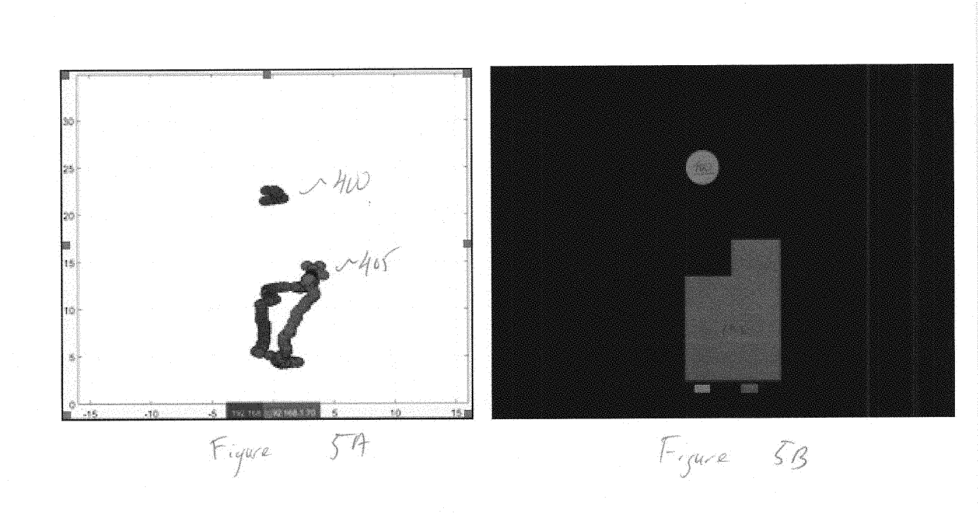

The quantization concept may be extended to include motionless individuals as (MLs) as discussed above. To ensure the highest classification capability, the detected motionless breathing is represented as a circle and automatically labeled as “ML” and placed in the corresponding quantized area in the scanned structure image data. Two sets of ML and PL labeled images were then selected to demonstrate the feasibility of predicting new image sets that were not included in the trained database. For example, consider the scan results shown in FIG. 4A. In this case, UWB radar system 100 was used to scan along a 30 foot wall of a structure as discussed with regard to FIG. 2A The resulting scan data is quantized into 5 foot by 5 foot spaces or areas. It will be appreciated that more fine quantizing (for example, 1 foot by 1 foot) may be performed in alternative embodiments. As shown in FIG. 5A, a motionless individual 400 and a pacing individual 405 were detected. Detection after quantization by the 5 foot by 5 foot spaces is shown in FIG. 5B.

An image set of 823 images contained 356 ML images and 467 PL images from the 2 classes. With 24,606,720 features, the 12,303,360 strongest features were identified for each class, and using K-Means clustering the program created a 1,000 word visual vocabulary. The sets were encoded and trained with various classification learners. It was found out that a linear support vector machine (“SVM”) yielded the best classification. Training processing lasted for 16 minutes for 22 iterations on a 64-bit Intel quad core i7-4702MQ 2.2 GHz CPU and 16 GB RAM. Removing the color and re-running the program on binary images yielded less than 0.5% accuracy loss, however, reduced the processing time to 7 minutes. As discussed with regard to FIG. 4, the sets were split into training and validation data. Thirty percent (30%) of each set of images was used to train the data and the remaining, seventy percent (70%) was used for data validation. The splits were also randomized to avoid biasing the results. The training and test sets were then processed by the CNN model. The resulting statistical accuracies of prediction are 99% for one motionless individual and one pacer, 99% for two motionless individuals and one pacer, 99% for one pacer, 97% for two pacers and 73% for the three pacers. In this test, all unseen objects were correctly identified. Three hundred fifty six (356) samples were used for each category. The processing time was about 11 minutes and 9 minutes for color and binary images, respectively. Note that all created labeled images created post training will be processed in virtual realtime so that a scenario of persistent temporal scene is accumulated overtime that can be used for behavioral analysis of an individual's pacing pattern. This pattern can be further processed to identify whether a person is stressed vs. calm based on the sequence of person's movements. For example, the differences between a first labeled image vs. a subsequent second labeled image may be reviewed to generate a temporal map of an individual's movements.

In addition, it will be appreciated that the CNN processing may be performed offline such as by uploading the labeled images to the cloud and performing the CNN processing using cloud computing. A user or system may thus remotely monitor the processed CNN images through a wireless network. Traffic planning and efficiency of crowd movement may then be performed using the persistent CNN temporal tracking. Moreover, the techniques and systems disclosed herein may readily be adapted to the monitoring of crowd movement towards a structure. The resulting radar images would thus not be hampered by imaging through a wall.

Static Detection of Walls

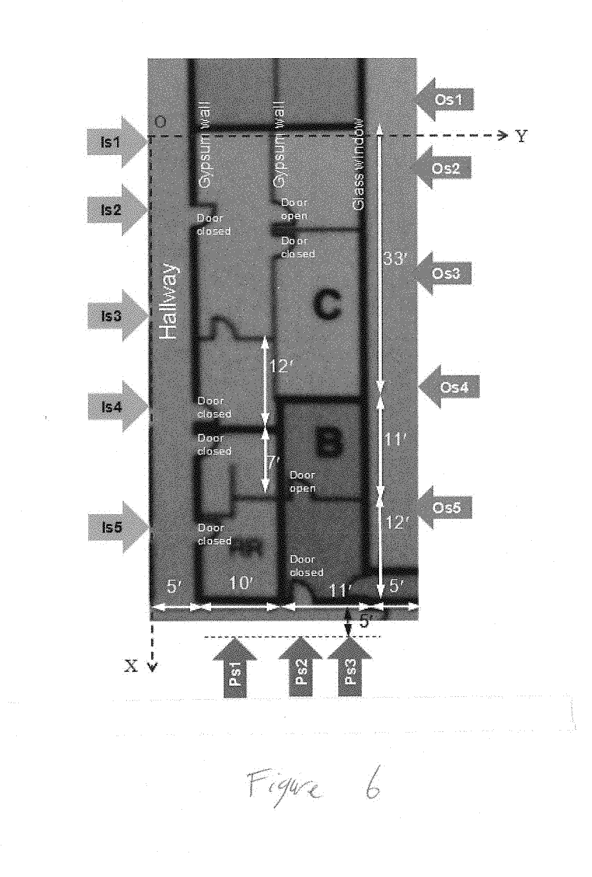

The machine detection of individuals behind walls may be enhanced with a static depiction of the wall locations within the scanned structure. Note that an array of UWB sensors can be used for estimating the location of walls of a premise for a very fast image construction time. Alternatively, only one UWB sensor can be used to scan the perimeter of a building by hand or mounted on a robot to construct the layout image. A scenario for data collection at multiple positions around typical office spaces is shown in FIG. 6. Note that the floor-plan is not drawn to scale. The office spaces were mostly empty during at the time of data collection. The walls running parallel and perpendicular to the hallway are made of gypsum, whereas the walls on the opposite side are made of glass (typical glass windows). The office space has doors that are all made of wood. The left and bottom walls were made of drywall stucco finish.

At least three sparse locations are necessary on each side of the premise for wall mapping. A set of five scanning locations, with the arrow-head pointing in the direction of radar ranging, are denoted by Is1, Is2, Is3, Is4 and Is5 as shown in FIG. 6. The separation between Is1-Is2, Is2-Is3, Is3-Is4, Is4-Is5 were 5 ft., 12 ft., 12 ft. and 14 ft., respectively.

The scan locations on the opposite side of the building are denoted by symbols Os1, Os2, Os3, Os4 and Os5. The separation between Os1-Os2, Os2-Os3, Os3-Os3, and Os4-Os5 were also 5 ft., 12 ft., 12 ft. and 14 ft., respectively. However there was a 5 ft. offset between the Is1-Is5 and Os1-Os5 sets. The scan locations perpendicular to the hallway are denoted by Ps1, Ps2 and Ps3, with 5 ft. separation between both Ps1-Ps2 and Ps2-Ps3. All the scan locations were at a 5 ft. stand-off distance from the walls in front of the sensor, and were held at 5 ft. above the ground. Raw data over the 1-33 ft. range with 12.7 ps time step and 10 MHz pulse repetition frequency (PRF) were collected using the prepared scanning software. At each scan location, multiple waveforms were recorded using an envelope detector filter in the scanning software. Multiple waveforms (30 for the current tests) collected at a given scan location can be used to perform an integration of such waveforms to give an improved signal-to-noise-ratio (SNR).

The motivation behind capturing data at the opposite sides of the office perimeter (Os1-Os5) is to spatially correlate the multiple echoes from the walls and other objects with those observed in the waveforms collected from the other side (Is1-Is5). The echoes observed later in time (or farther in range) in the Is1-Is5 locations are expected to be spatially correlated with the echoes, stronger and closer in range, in the waveforms measured at locations (Os1-Os5) as long as: (a) the separation between the scan set of Is1-Is5 and Os1-Os5 set is less than the maximum unambiguous radar range (30 ft for the current case), (b) the scan locations Os1-Os5 lie inside the sensor antenna's −3 dB beamwidth (˜300) overlap with the corresponding locations in the Is1-Is5 set or vice versa, and (c) the waveforms at Os1-Os5 locations are time aligned with those from the Is1-Is5 locations with the a priori knowledge of the physical separation between the two scan location sets (at least the width of the building). In a real-life operational scenario, this information on the separation between the two opposite scan locations can be easily obtained by the radar itself. This dual information at opposite sides of the premise can give a higher probability of detection and hence a more reliable mapping of walls and other static, reflective objects inside the space, especially when the SNR can be lower for the data measured from one side. For situations when information is limited to only on one side of the space, then this information can still be used for mapping. Data measured at locations Ps1-Ps5 perpendicular to the hallway can provide information related to perpendicular walls and other static objects inside the premise that cannot be detected in the data at Is1-Is5 and Os1-Os5 locations.

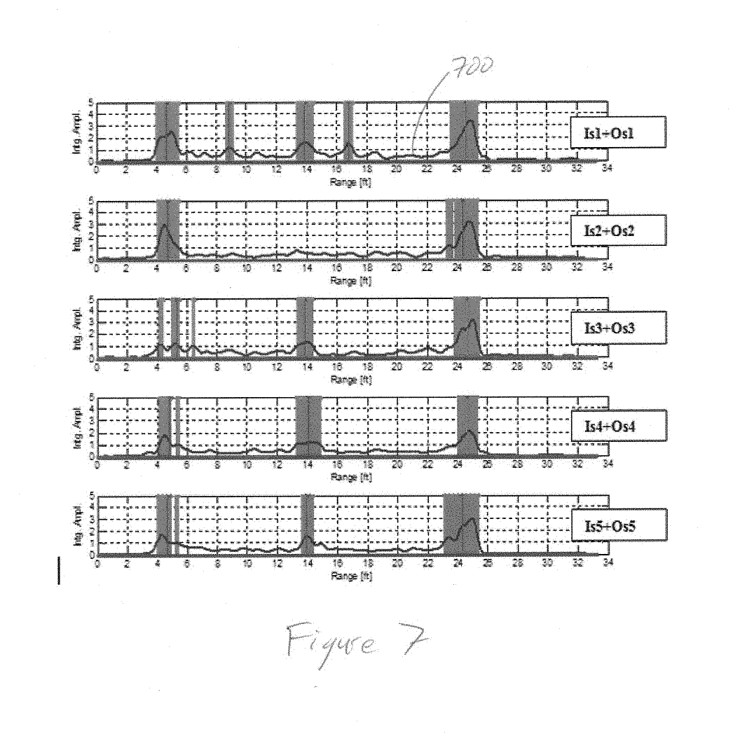

Further enhancement of the SNR of the waveform can be achieved at each scan location by summing the successive waveforms. The resultant waveforms, after summing the multiple (30) waveforms shown in FIG. 7 at each scan location, followed by a N-tap moving average filter, are shown as plots 700. The moving average filter is used to further smooth the noise in the summed waveforms. In this particular case, N has been chosen to be 100. The peaks for plots 700 correspond to the location of detected walls or partitions.

A higher CFAR threshold raises the possibility of missed detection of wall locations, whereas a lower CFAR threshold increases the probability of the false estimation of wall locations, especially when multiple time-delayed reflections from static objects (clutter) inside the rooms are present. Once the markers corresponding to estimated wall locations are generated, a 2-dimensional “binary” image is formed with these marker coordinates. Dimensions of each pixel in the x and y axes are chosen to be 0.63 ft. (i.e., 100 times the range-bin size of 0.0063 ft in the raw waveforms). Additionally the size of the image grid along each axis is chosen to be at least greater than the maximum extent of the scans along that axis plus the stand-off distance of the sensor from the wall. In the present case, the image grid is chosen to be a square with each side equal to 60 ft.

With the image grid populated with the wall-coordinate pixels estimated from multiple scan locations parallel to the long hallway, the walls parallel to the hallway may be demarcated by straight lines using a suitable criterion. This criterion is such that if the number of “white” pixels along “Parallel to hallway” axis at a fixed pixel location on the “perpendicular to hallway” axis exceeds some specified number (Np), then a straight line indicating the wall location is drawn at the specific “perpendicular to hallway” pixel passing through these pixels. Three straight lines are obtained with Np=3. These walls correspond to the front gypsum-walls, middle gypsum-walls and the glass-walls in FIG. 6.

The waveforms collected at positions PS1, PS2, and PS3 may be processed analogously as discussed with regard to FIG. 7 to estimate locations of walls from these scanning positions. Combining the data from the horizontal and vertical scans leads to a final 2-D reconstructed image of the wall locations. The resulting 2D image may be processed such as through Matlab functions to produce a 3-D image of the walls. With the walls imaged in at least 2 dimensions, the static scan may be overlaid onto the quantized images discussed earlier to show the positions of the pacing and motionless individuals within the rooms defined by the imaged walls.

It will be appreciated that many modifications, substitutions and variations can be made in and to the materials, apparatus, configurations and methods of use of the devices of the present disclosure without departing from the scope thereof. In light of this, the scope of the present disclosure should not be limited to that of the particular embodiments illustrated and described herein, as they are merely by way of some examples thereof, but rather, should be fully commensurate with that of the claims appended hereafter and their functional equivalents.

I claim:

1. A method of using a convolutional neural network to identify pacing and motionless individuals inside a structure, comprising:
positioning a pair of ultra-wide band (UWB) radar sensors along a wall of the structure;
transmitting a train of UWB impulses from each of the UWB radar sensors to receive a corresponding train of received UWB impulses at each UWB radar sensor;
arranging a search space within the structure into a plurality of search bins;
processing the train of received UWB impulses from each UWB radar sensor to detect whether a pacing individual is within each search bin;
labeling each search bin having a detected pacing individual with a first label to produce a labeled image of the search space; and
processing the labeled image through a convolutional neural network to classify the labeled image as to how many detected pacing individuals are illustrated by the labeled image.

2. The method of claim of claim 1, further comprising:
processing the train of received UWB impulses from each UWB radar sensor to detect whether a motionless individual is within each search bin by detecting whether the motionless individual is breathing; and
labeling each search bin having a detected motionless individual with a second label to augment the labeled image of the search space, wherein processing the labeled image through the convolutional neural network to classify the labeled image as to how many detected pacing individuals are illustrated by the labeled image further comprises classifying the labeled image as to how many motionless individuals are illustrated by the labeled image.

3. The method of claim 1, further comprising:
collecting a plurality of additional labeled images;
providing a pre-trained convolutional neural network that is pre-trained on an image database that does not include the additional labeled images; and
training the pre-trained convolutional neural network on the plurality of additional labeled images to classify each labeled frame into a single pacing individual category, a pair of pacing individuals category, and a three pacing individual category to provide a trained convolutional neural network, wherein processing the labeled image through the convolutional neural network comprises processing the labeled image through the trained convolutional neural network.

4. The method of claim 1, wherein a pulse repetition frequency for each UWB radar sensor is within a range from 100 MHz to 10 GHz.

5. The method of claim 1, further comprising:
imaging a plurality of walls within the structure to provide an image of the plurality of walls, and
overlaying the labeled image over the image of the plurality of walls.

6. The method of claim 1, wherein transmitting the train of UWB impulses from each of the UWB radar sensors to receive the corresponding train of received UWB impulses at each UWB radar sensor comprises transmitting the train of UWB impulses through a first array of antennas and receiving the corresponding train of received UWB impulses through a second array of antennas.

7. The method of claim 1, wherein processing the labeled image through the convolutional neural network further comprising uploading the labeled image through the internet to the convolutional neural network.

8. The method of claim 1, wherein processing the labeled image further comprises comparing the labeled image to a subsequent labeled image to generate a temporal map of individual movements.

9. The method of claim 8, further comprising analyzing the temporal map of individual movements to determine whether an individual is calm or agitated.

10. A system to identify pacing and motionless individuals inside a structure, comprising:
a pair of ultra-wide band (UWB) radar sensors positioned along a wall of the structure, wherein each UWB radar sensor is configured to transmit a train of UWB impulses and to receive a corresponding train of received UWB impulses;
a signal processor configured to process the received trains of UWB impulses to produce an image of a plurality of search bins within the structure, wherein the signal processor is further configured to label each search bin with a first label in response to a detection of a pacing individual within the search bin to produce a labeled image; and
a convolutional neural network configured to classify the labeled image as to how many detected pacing individuals are illustrated by the labeled image.

11. The system of claim 10, further comprising additional UWB radar sensors positioned along the wall of the structure.

12. The system of claim 10, wherein the convolutional neural network further comprises a linear support vector machine.

13. The system of claim 10, wherein the signal processor is further configured to label each search bin with a second label in response to a detection of a motionless individual within the search bin.

14. The system of claim 10, wherein each UWB radar sensor is configured to use a pulse repetition frequency in a range from 100 MHz to 10 GHz.

15. The system of claim 10, wherein the convolutional neural network is located remotely from the UWB radar sensors, and wherein the convolutional neural network is configured to receive the labeled image through the Internet.

16. The system of claim 10, wherein the signal processor is further configured to overlay the labeled image with an image of walls within the structure.
